(19) United States
(12) Patent Application Publication
(10) Pub. No.: US 2025/0310302 A1
(43) Pub. Date: Oct. 2, 2025

(54) Method and System for Identification and Retrieval of Data of Interest in an OPC UA PubSub Automation Network

(71) Applicant: ABB Schweiz AG, Baden (CH)

(72) Inventors: Sten Grüner, Laudenbach (DE); Abdulkadir Karaagac, Renningen (DE); Roland Braun, Niederkassel Lülsdorf (DE); Jens Heuschkel, Weiterstadt (DE); Rhaban Amelung, Griesheim (DE)

(73) Assignee: ABB Schweiz AG, Baden (CH)

(21) Appl. No.: 19/087,839

(22) Filed: Mar. 24, 2025

(30) Foreign Application Priority Data
Mar. 25, 2024 (EP) 24165802

(51) Int. Cl. H04L 9/40

(52) U.S. Cl. CPC H04L 63/0281

(57) ABSTRACT

A method for identification and retrieval of data of interest in an OPC UA PubSub automation network, wherein the OPC UA PubSub automation network comprises at least one publisher. The method includes providing publisher data, connecting a gateway device to the OPC UA PubSub automation network, discovering at least one information source in the OPC UA automation network, identifying and connecting to a broker by the gateway device, wherein the broker manages the publisher data provided by the at least one publisher, determining, by the gateway device, at least one matched information source from the discovered at least one information source based on information intent and PubSub meta information provided by the broker, and retrieving, by the gateway device, the data of interest from the at least one matched information source.

### CROSS-REFERENCE TO RELATED APPLICATIONS

The instant application claims priority to European Patent Application No. 24165802.0, filed Mar. 25, 2024, which is incorporated herein in its entirety by reference.

### FIELD OF THE DISCLOSURE

The present disclosure generally relates to a method and system for efficient discovery and processing of machine-readable publisher information sources in an OPC UA PubSub automation network.

### BACKGROUND OF THE INVENTION

In contemporary methods of information retrieval within the OPC UA PubSub network via gateway devices, discovering data of interest along with their sources, as well as identifying field devices and their associated parameters, typically requires manual configuration. This process involves compiling a list of endpoints, including IP addresses of devices or brokers and topic trees, and configuring cybersecurity measures to ensure secure data collection. Following this setup, users are required to manually navigate through available information and select the desired data.

Manual configuration in PubSub networks poses several challenges that can hinder efficiency and scalability. Firstly, the process is time-consuming and prone to errors, as it relies heavily on human intervention. Mistakes in compiling endpoint lists or configuring cybersecurity measures can lead to security vulnerabilities or data inconsistencies. Additionally, the manual selection of data of interest may result in overlooking valuable information or selecting irrelevant data, leading to suboptimal system performance. Furthermore, as the network grows in complexity with an increasing number of devices and data sources, manual configuration becomes increasingly cumbersome and difficult to manage. This can impede the ability to adapt the network to evolving requirements and technologies efficiently.

Overall, the reliance on manual configuration in PubSub networks highlights the need for automated solutions to streamline operations and enhance system reliability. The problem to be solved is the reduction of the above-mentioned manual, time-costly and error-prone efforts to configure manually the gateway device in the OPC UA PubSub automation network.

### BRIEF SUMMARY OF THE INVENTION

According to an aspect of the present disclosure, a method for identification and retrieval of data of interest in an Open Platform Communications Unified Architecture, OPC UA, PubSub automation network is described. The OPC UA PubSub automation network comprises at least one publisher, providing publisher data. The method includes connecting a gateway device to the OPC UA PubSub automation network. The method further includes discovering, by the gateway device, at least one information source in the OPC UA PubSub automation network. Identifying and connecting to a broker by the gateway device, wherein the broker manages the publisher data provided by the at least one publisher. The gateway device determines at least one matched information source from the discovered at least one information source based on information intent of the gateway device and PubSub meta information of the publisher data provided by the broker, and the gateway device retrieves the data of interest from the at least one matched information source.

### BRIEF DESCRIPTION OF THE SEVERAL VIEWS OF THE DRAWING(S)

FIG. 1 is a schematic diagram of a system for identification and retrieval of data of interest in a broker-based OPC UA PubSub automation network according to an embodiment of the present disclosure.

FIG. 2 is a flowchart for a method of identification and retrieval of data of interest in a broker-based OPC UA PubSub automation network according to another embodiment of the present disclosure.

### DETAILED DESCRIPTION OF THE INVENTION

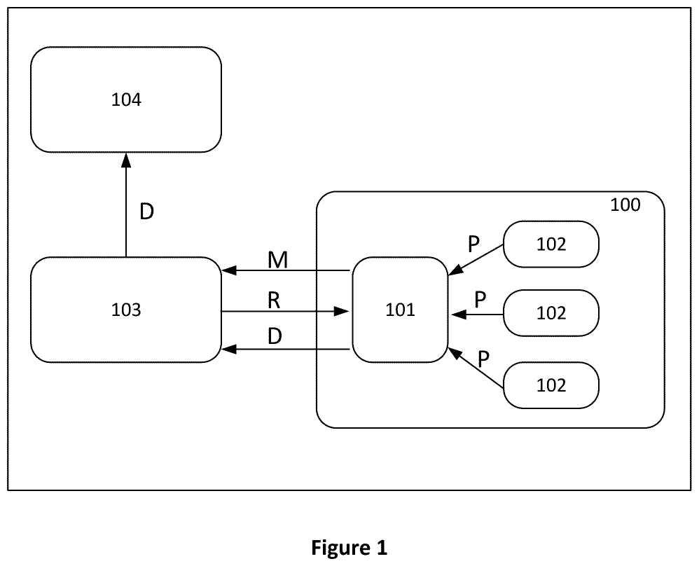

FIG. 1 illustrates a schematic diagram of a system for identification and retrieval of data in an OPC UA PubSub automation network 100 comprises the following. At least one publisher 102, configured to provide publisher data P. A broker 101, configured to manage the publisher data P provided by the at least one publisher 102. A gateway device 103, configured to connect to the OPC UA PubSub automation network 100, discover at least one information source in the OPC UA PubSub automation network 100, identify and connect to a broker 101, determine at least one matched information source from the discovered at least one information source based on information intent and semantic information provided by the broker 101, and retrieve the data of interest D from the at least one matched information source. In order to find information sources matching to the interest of the gateway device 103, the gateway device 103 receives PubSub meta information M of the publisher data P from the broker. The gateway device 103 uses the semantic information S and information intent I of the gateway device 103 that reflects the interest of the gateway device 103 to find the interesting topics and respective information sources matching the interest of the gateway device 103. With the help of a subscription request R, the gateway device 103 subscribes to the matched information sources at the broker 101 to retrieve the data of interest.

Preferably, the OPC UA PubSub automation network further comprises OPC UA nodes like Global Discovery and Alias servers GDS, Secure Key Service SKS, FX managers, and Ordinary OPC UA servers wherein these nodes will be discovered by the gateway device.

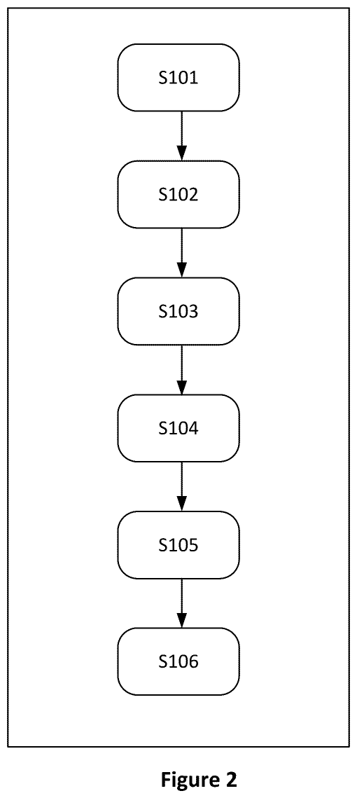

FIG. 2 is a flowchart of the method of identification and retrieval of data of interest in an OPC UA PubSub automation network according to an embodiment of the application. The method provided in this embodiment of this application includes the following steps.

In the first step S101, a gateway device to the OPC UA PubSub automation network, will be connected. In the second step S102, at least one information source in the OPC UA PubSub automation network, will be discovered. In the next step S103, a broker by the gateway device will be identified and the gateway device will be connected to the broker, wherein the broker manages the publisher data provided by the at least one publisher.

In the next step S104, by the gateway device, at least one matched information source from the discovered at least one information source based on information intent and PubSub meta information provided by the broker, will be determined. In the next step S105, by the gateway device, the data of interest from the at least one matched information source will be retrieved.

Preferably, in the next step S106, by the gateway device, the data of interest to at least one other network assessments, will be provided. Provided data may be re-published by the gateway device towards a cloud-hosted broker.

In one embodiment, the obtained data by the gateway will be re-published into a cloud system, typically via a broker based OPC UA PubSub. Preferably, the providing comprises outputting, by the gateway device the data of interest for users.

As contemplated herein, OPC UA is a cross-platform, IEC 62541 standard for data exchange from sensors to cloud application. In other words, OPC UA provides a standardized way to exchange data between different OPC UA nodes in an OPC UA network.

The term “OPC UA PubSub automation network”, as used herein, describes a PubSub network based on the OPC UA. PubSub provides an asynchronous messaging model between so called publisher, which provide publisher data in a broadcast manner or to a broker component, and so-called subscriber, which consume the provided publisher data. The publishers provide their publisher data independent from the subscribers. Each publisher data is associated with a topic. The subscribers subscribe to topics that they are interested in and receive the respective publisher data. In other words, the publishers have no information about who uses the provided publisher information, and the subscribers have no information who provides the publisher information. Thus, due to PubSub communication pattern, Publishers and Subscriber are loosely coupled, i.e., they may be not aware of each other at all.

The term “gateway device”, as used herein, comprises a physical entity and/or logical entity. In other words, the gateway device comprises devices and/or services. Preferably, the gateway device consumes, processes and/or ingests information provided within the OPC UA PubSub automation network. Preferably, connecting a gateway device to the OPC UA PubSub automation network comprises connecting physically (plug in) or wireless the gateway device into the OPC UA PubSub automation network, and/or installing a software or service to the OPC UA PubSub automation network.

The term “information source”, as used herein, relates to any OPC UA entity, also referred to as OPC UA node, in the OPC UA PubSub automation network that provides information. This for example comprises publishers but also the broker or other data servers. The term “data of interest”, as used herein, comprises information within the OPC UA PubSub automation network that may be of interest to either a user accessing the gateway device or the gateway device itself. The term “publisher”, as used herein, comprises a physical or logical entity providing information or events. Preferably, the publisher comprises a field device like a sensor or an actuator. Publishers publish data using OPC UA PubSub compliant protocol like Unified Architecture Datagram Protocol, UADP, Message Queuing Telemetry Transport, MQTT, or Advanced Message Queuing Protocol, AMQP. Publishers may implement OPC UA client/server, CS, communication in addition to the PubSub protocol.

The OPC UA PubSub automation network comprises further at least one subscriber. The term “subscriber”, as used herein, comprises a physical or logical consumers of information provided by Publishers. Subscribers use the same protocol as Publishers. Additionally, they might also implement OPC UA CS communication. Preferably, the subscriber is a physical or logical entity wherein subscriber obtain and consume data provided by the at least one publisher. Preferably, subscribers need to define the at least one set of topics they are interested in. An OPC UA PubSub automation network participant can be a publisher and a subscriber at the same time.

Preferably, the identifying and connecting to a broker by the gateway device further comprises detection whether the OPC UA PubSub automation network is broker-based. Preferably, the OPC UA PubSub automation network is a broker-based OPC UA PubSub automation network. Preferably, identifying and connecting to a broker by the gateway device further comprises automatic discovery of the broker.

The term “broker”, as used herein comprises a message broker. In case of some protocols, like MQTT or AMQP a dedicated “broker” component is required, which acts as a middleware between “publisher” and “subscriber”.

Preferably, the identifying and connecting to a broker by the gateway device further comprises detection of broker URL/IP from OPC UA PubSub automation network. Preferably, the broker in the OPC UA PubSub automation network is a MQTT broker, wherein the MQTT Broker describes a Message Queuing Telemetry Transport broker. Thus, an automatic method for identifying the broker and connecting to it by the gateway device is provided.

Further, the method provides integration of the gateway device into the OPC UA PubSub automation network. Preferably, after identifying the broker and connecting to it by the gateway device, the method further comprises discovering the at least one of the OPC UA nodes within the OPC UA PubSub automation network, wherein the OPC UA nodes comprise Global Discovery and Alias servers, GDS, Secure Key Service, SKS, FX communication managers, and Ordinary OPC UA servers.

GDS is an optional OPC UA node that allows to list OPC UA CS server which can be registered on it. Discovery functionality can be implemented within a central unity or in a decentralized manner using LDS-ME (mDNS) or similar technologies.

SKS is an optional OPC UA node that is used to distribute keys for message security in case an encryption is used between publishers and subscribers. SKS is implemented using a set of predefined OPC UA nodes/methods.

FX Communication Manager is an optional OPC UA node maintaining and applying the OPC UA FX connection configuration—this is a set of high-level bi-directional configurations between publishes and subscribers. FX connections are abstractions of two bi-direction PubSub connections between a publisher and subscriber.

Preferably, the gateway device connects to the discovered elements within the OPC UA PubSub automation network. Connecting to the GDS or SKS, by the gateway device may require broker credentials. Thus, an automatic method for identifying OPC UA nodes within the OPC UA PubSub automation network and connecting to them by the gateway device is provided.

The user may be prompted to provide needed credentials and/or certificates needed for the connection to the GDS or SKS. Preferably, the discovering the at least one of the OPC UA nodes further comprises obtaining the address of said discovered elements by scanning PubSubConnection-typed objects within discovered elements. The term “OPC UA information model” comprises organizational framework that defines, characterizes, and relates information sources of the OPC UA PubSub automation network. Preferably, the OPC UA information models comprises known object types or dictionary references.

Preferably, the publisher data comprise information about OPC UA nodes and/or subset information which is been already published by the publisher. Further, this information is encoded into the OPC UA information model, wherein this information is obtained either directly by the publisher itself, or by using an intermediate information source like an OPC UA aggregating server. Preferably, the determining, by the gateway device, at least one matched information source further comprises search and selection of information sources based on information intent wherein the information intent is pre-defined data intent, pre-configured data intent and/or application-specific data intent.

Preferably, the information intent comprises a text query and/or a structural query describing the information of interest.

Preferably, after discovering at least one information source in the OPC UA PubSub automation network, a set of matching information and its source is filtered, wherein the matched information and its source is compared to the information intents.

Preferably, the matching process can be supported by included semantic information within the OPC UA information models like known object types or dictionary references.

Preferably, technical implementation of the matching process includes natural language processing, structured queries, and further matching techniques.

In an example, informal query formulation could be “active speed output of a variable frequency drive”. In another example, more formal query formulation could be “current setpoint parameter of device 1”. Thus, an improved automated method for determining and discovery the information source in the OPC UA PubSub automation network is provided.

Preferably, the selection of information sources comprises using PubSub meta information, wherein for example the PubSub meta information comprises frequency of updates, topic names or names of FX connections. Preferably, the determining, by the gateway device, at least one matched information source further comprises using OPC UA alias mechanisms to resolve a list of alternative OPC UA variable names, wherein the OPC UA alias mechanisms comprises mechanisms for determining alternate well-defined name for any node in the system.

Preferably, the determining, by the gateway device, at least one matched information source further comprises using PubSub and OPC UA FX extension of information search, wherein said extension comprises using additional dynamic semantics of emerging and changing FX connections and/or implicit dependencies between publishers and subscribers (e.g., knowledge that a PLC is broadcasting to the same group which drive's setpoint is subscribed to). Thus, an improved automated method is provided for determining matched information source from the discovered at least one information source based on information intent of the gateway device and PubSub meta information of the publisher data provided by the broker within the OPC UA PubSub automation network.

Preferably, retrieving, further comprises redundancy detection of data of interest. Preferably, retrieving comprises subscribing to an already published data, or re-configuring the provider within the OPC UA PubSub automation network.

The method may further comprise periodic detection of joining/disjoining devices and OPC UA nodes, for example mobile devices such as AGVs. In an example, an edge computer discovers generally available information of OPC UA nodes and information subset which has been already published using OPC UA PubSub techniques wherein this information is encoded into the OPC UA information model.

Preferably, the method further comprises after retrieving, obtaining the data of interest, by the gateway device. Preferably, the method is a computer-implemented method.

In an example, the gateway device obtains matched information sources of OPC UA nodes and information subset which have been already published using OPC UA PubSub techniques wherein said information is encoded into the OPC UA information model.

Considering PubSub meta information of the publisher data and information intent of the gateway device to determine the matched information sources using a broker allows to reuse existing published DataSetMessages of publisher data and/or existing security groups. For example, in case a dedicated publisher is already providing some information matches gateway device data of interest, it does not aim to re-creating an additional publishing request to the publisher, but instead subscribes to an already existing published data set.

Thus, an improved automated method is provided for a gateway device to allow its integration into an available OPC UA PubSub automation network for the purpose of a semi-automated information flow discovery, based on the information intent and PubSub meta information of the publisher data.

In a preferred embodiment, the method further comprises providing, by the gateway device, the data of interest to at least one other network. Providing, by the gateway device, the data of interest to at least one other network describes PubSub reusing the data of interest. Retrieved, or in other words obtained, data of interest may be re-published by the gateway device to another network via a cloud-broker.

Preferably, the obtained data by the gateway will be ingested into a cloud system, typically via a broker based OPC UA PubSub. Obtained data of interest may be ingested or may be processed by the gateway device. Preferably, instead of ingestion, the gateway device process locally the obtained data from OPC UA PubSub automation network (e.g., gateway device calculates OEE (overall equipment efficiency) of a dedicated device based on its operational state).

Preferably, the providing, by the gateway device, the data of interest to at least one other network further comprises efficient cloud ingestion by passing local published data to the cloud-broker with minimal modifications.

In an example, if the OPC UA PubSub automation network within the factory network is broker-based, a large amount of obtained data, namely the data set payload, may be reused directly to allow a more efficient ingestion. In this case the gateway device needs to modify the data of interest to forward it to the cloud-broker. One advantage of this method is that it reduces the necessity for the gateway device to decode the payload of the data of interest. While an encoding-conversion may be needed to match the requirements of the cloud-broker for example encoding from binary-based UADP to text-based JSON.

Additionally, the gateway device can take over the task of uploading the relevant information model fragments to the cloud-broker or the OPC UA cloud library based on the information within the local OPC UA servers.

Preferably, the providing comprises outputting, by the gateway device the data of interest for users. Thus, an improved method for providing the retrieved data of interest to at least one other network, is provided.

In a preferred embodiment, the other network comprises a cloud system. Thus, an improved method for providing the retrieved data of interest to at least one other cloud network, is provided.

In a preferred embodiment, the providing the data of interest comprises transforming the data of interest into a format, readable for the other network. Preferably, if no transmission control protocol, TCP, communication is used within the OPC UA PubSub automation network (e.g., User Datagram Protocol, UDP, based PubSub), published data are transformed into suitable format and re-published, wherein the TCP is a connection-based protocol and the UDP is connectionless.

In a preferred embodiment, the retrieving the data of interest from the at least one matched information source comprises determining and determining comprises following steps. If the matched information source has been already published by at least one of the publishers, the method further comprises subscribing, by the gateway device, the publisher associated with the data of interest. And if the matched information source has not been already published by at least one of the publishers, the method further comprises requesting, by the gateway device, PubSub re-configuration within the OPC UA PubSub automation network.

Preferably, the retrieving the data of interest further comprises a search to perform whether the data of interest is already published by at least one of publishers within the OPC UA PubSub automation network.

Preferably, if the data of interest has been published by a publisher, the gateway device subscribe the publisher, wherein the configuration of publisher will not be changed.

Preferably, subscribing further comprises adding gateway device to a list of subscribers of the publisher published data without changing configuration of OPC UA PubSub automation network wherein the configuration of OPC UA PubSub automation network comprises non-real-time communication.

Preferably, subscribing further comprises adding gateway device to the list of subscribers of the publisher without additional sampling load on the publisher.

To collect the data of interest as efficient as possible, this method further comprises re-using existing published DataSetMessages containing the data of interest where possible. Based on the knowledge of existing publishers and information they publish; the gateway device identifies required publishes (data of interest) and PublishedDataSets with the associated security group.

The term “DataSetMessage” comprises an immutable payload of the OPC UA PubSub automation network message handed off to the broker for delivery by the publisher.

The term “PublishedDataSets” comprise a list of monitored variables or an event selection.

Preferably, the gateway device joins an existing security group by contacting responsible SKS and obtains the needed cryptographic keys to decrypt the obtained data.

Preferably, if the matched information source has not been already published by at least one of the publishers, the gateway device sends a PubSub re-configuration request within the OPC UA PubSub automation network.

Preferably, the requesting PubSub re-configuration requires confirmation of the user and/or the user is required to provide needed information (e.g., credentials/keys).

Furthermore, a PubSub re-configuration may be needed to allow an additional subscriber to join the publisher, in case a real-time communication protocol (e.g., IEEE TSN) is used.

Preferably, if an existing publisher configuration cannot be reused due to failure of obtaining the keys, the gateway is tried out a creation of a new PublishedDataSet, by using available FX communication manager, or interacting with respective PubSub configuration within the identified publisher.

Preferably, if creation of a new PublishedDataSet is failed, a fallback to OPC UA client/server-based communication is tried out, by the gateway device, relying on OPC UA client/server subscription mechanisms, wherein these mechanisms are not to be mixed with the OPC UA PubSub.

Thus, an improved automated method for subscribing the publisher published data of interest, is provided. Furthermore, in case no publisher is found, the re-configuration requesting will be performed by the gateway device.

In a preferred embodiment, the at least one matched information source is determined using an OPC UA Information model, providing information about entities and data in the OPC UA PubSub automation network Preferably, information model browsing upfront involves examining, by the gateway device, structure of the published data within the OPC UA PubSub automation network before actively participating in it and subscribing to the related publisher.

In an example, before subscribing specific topics, the gateway device in the OPC UA PubSub automation network would analyze the available information models to understand the types of data being published, the format of data and/or messages, and the relationships between different topics or channels. This upfront exploration ensures that the gateway device has a clear understanding of the data flow and can make informed decision about which topics to subscribe to.

Preferably, by browsing the information model upfront, edge device can avoid misunderstandings, identify potential data sources. Thus, compatibility between publishers and gateway device within the OPC UA PubSub automation network will be ensured. Thus, an improved automated method for the examining and analyzing the structure of the published data within the OPC UA PubSub automation network, by the gateway device before subscribing to the related publisher, is provided.

Preferably, the determining the at least one matched information source comprises using PubSub-specific properties.

Preferably, the determining the at least one matched information source comprises using OPC UA PubSub specifications for identification, selection and processing the published device information and the PubSub meta information.

Preferably, the determining the at least one matched information source comprises using concepts of OPC UA FX, which extend OPC UA PubSub for identification, selection and processing the published data, related sources, and the PubSub meta information.

An alternative information source may be the FX communication manager since it contains a high-level data flow between publisher and subscriber wherein an abstraction is used called functional entity.

Thus, an improved automated method for the identification, selection and processing the published data, related sources, and their PubSub meta information within the OPC UA PubSub automation network, is provided.

In a preferred embodiment, the PubSub-specific properties comprise publishing intervals and/or information about publisher describing the information intent.

Preferably, the PubSub-specific properties comprise publishing intervals and/or information about publisher and subscribers describing the information intent within the structural queries describing the information-intent.

In an example for the PubSub-specific properties could be “setpoint published at least every 100 ms” or in another example it could be or “setpoints with at least one subscriber”.

Regarding the information about publisher and subscribers it should be considered that normally obtaining publisher/subscriber dependencies may be not possible due to the loose coupling mechanisms roots of PubSub patterns and may require elevated rights to access non-standardized diagnostic information of the broker.

Thus, an improved automated method for determining the matched information source within the OPC UA PubSub automation network, is provided.

In a preferred embodiment, the information intent comprises semantic information. The term “semantic information”, as used herein, comprises information about the information intent like topics. Preferably, the semantic information comprises meaning or content conveyed by the information intent. Preferably, the semantic information interprets the information intent, including the relationships and connections between different pieces of information and topics.

Preferably, the semantic information understands the context and significance of the information intent, in relation to the concepts, entities, or ideas represented by the information intent. Thus, an improved automated method for determining the matched information source based on semantic information of the information intent within the OPC UA PubSub automation network, is provided.

Preferably, the PubSub meta information comprises frequency of updates, topic names and/or names of FX connections. Preferably, PubSub meta information comprises topic names, subscription detail message attributes publisher and subscriber information configuration settings. Preferably, the PubSub meta information provides information about the topic, including its purpose, access permissions, message format, and attributes. This PubSub meta information helps the gateway device understand the type of published data on the topic and how to interpret it effectively. Thus, an improved automated method for understanding the type of published data on the topic and how to interpret it by the gateway device is provided.

In a preferred embodiment, the method further comprises obtaining, by the gateway device, security data from the broker, wherein the security data allows the gateway device to retrieve encrypted data of interest.

Preferably, the gateway device obtains security data and/or keys from the broker for message security in case an encryption is used between publishers and subscribers and/or to retrieve encrypted data of interest. Thus, an improved automated method for retrieving encrypted data of interest within the OPC UA PubSub automation network, is provided.

In a preferred embodiment, the gateway device comprises an edge device gateway. The gateway device comprises a physical entity and/or logical entity. In other words, the gateway device comprises devices and/or services.

According to an aspect of the disclosure, a system for industrial information identification and retrieval in an OPC UA PubSub automation network, wherein the system is configured to perform the method, as described herein. According to another aspect of the disclosure, a system for identification and retrieval of data in an OPC UA PubSub automation network comprises the following. At least one publisher, configured to provide publisher data. A broker, configured to manage the publisher data provided by the at least one publisher. A gateway device, configured to connect to the OPC UA PubSub automation network, discover at least one information source in the OPC UA PubSub automation network, identify and connect to a broker, determine at least one matched information source from the discovered at least one information source based on information intent and semantic information provided by the broker, and retrieve the data of interest from the at least one matched information source.

Preferably, the system further comprises Global Discovery and Alias servers GDS, Secure Key Service SKS, FX communication managers, and Ordinary OPC UA servers wherein these elements will be discovered by the gateway device. Preferably, the OPC UA PubSub automation network comprises further Global Discovery Server GDS, allowing to list OPC UA CS server which can be registered on it. Preferably, in GDS, search and discovery functionality are implemented within a central unity or in a decentralized manner using LDS-ME (mDNS). Preferably, for connecting to the GDS may also be required to obtain needed credentials to log in into OPC UA entities, or user may be prompted to provide needed credentials and/or certificates and further information needed to log in. Preferably, the OPC UA PubSub automation network comprises further Secure Key Service SKS to distribute keys for message security in case an encryption is used between publishers and subscribers.

Preferably, SKS is implemented using a set of predefined OPC UA nodes/methods. Preferably, the OPC UA PubSub automation network comprises further OPC UA FX Communication Manager for maintaining and applying the OPC UA FX connection configuration. Preferably, the OPC UA FX connection configuration comprises a set of high-level bi-directional configurations between publishes and subscribers. Preferably, the OPC UA FX connections comprise abstractions of two bi-direction PubSub connections between a publisher and a subscriber.

The gateway device may use one or more of the following techniques to discover OPC UA nodes of OPC UA PubSub automation network: LDS-ME/mDNS, GDS, DHCP information obtained along with a DHCP lease, known DNS names which are dynamically re-mapped on site (e.g., broker edge), IP/Port scan, proprietary protocols, and user input. Further the gateway device uses asset administration shell submodels, to discover OPC UA nodes of OPC UA PubSub automation network, wherein asset administration shell submodels describes OPC UA endpoints explicitly via a submodel or implicitly via qualifiers or variable content.

The gateway device connects to the other OPC UA nodes of OPC UA PubSub automation network, like GDS or SKS, wherein needed credentials to log in will be required.

An example is presented in the following:
topic name: “WeatherData”,
description: a topic for publishing real-time weather updates,
permissions: gateway device and/or subscribers must have access to view this topic.
message format: JSON
“Location”: Specifies the geographical location for which the weather data pertains.
“Temperature”: Indicates the temperature at the specified location.
“Humidity”: Represents the humidity level at the specified location.
“Timestamp”: Provides the timestamp when the weather data was collected.

In this example, the PubSub meta information provides information about the “WeatherData” topic, including its purpose, access permissions, message format, and attributes. This PubSub meta information helps subscribers understand the type of data available on the topic and how to interpret it effectively.

According to an aspect of the disclosure, a computer program product, wherein when the computer program product runs on a computer, the computer is enabled to perform the method, as described herein. According to another aspect of the disclosure, a computer-readable storage medium comprising computer instructions, wherein when the computer instructions are run on a computer, the computer is enabled to perform the method, as described herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for identification and retrieval of data of interest in an Open Platform Communications Unified Architecture (OPC UA) PubSub automation network, wherein the OPC UA PubSub automation network comprises at least one publisher providing publisher data, the method comprising:
connecting a gateway device to the OPC UA PubSub automation network;
discovering, by the gateway device, at least one information source in the OPC UA PubSub automation network;
identifying and connecting to a broker, by the gateway device, wherein the broker manages the publisher data provided by the at least one publisher;
determining, by the gateway device, at least one matched information source from the discovered at least one information source based on information intent of the gateway device and PubSub meta information of the publisher data provided by the broker;
retrieving, by the gateway device, the data of interest from the at least one matched information source.

2. The method according to claim 1, wherein the method further comprises providing, by the gateway device, the data of interest to at least one other network.

3. The method according to claim 2, wherein the other network comprises a cloud system.

4. The method according to claim 2, wherein the providing the data of interest comprises transforming the data of interest into a format that is readable for the other network.

5. The method according to claim 1, retrieving the data of interest from the at least one matched information source comprises determining:
whether the matched information source has been already published by at least one of the at least one publishers, in which case the method further comprises subscribing, by the gateway device, the publisher associated with the data of interest; or
whether the matched information source has not been already published by at least one of the at least one publishers, in which case the method further comprises requesting, by the gateway device, PubSub re-configuration within the OPC UA PubSub automation network.

6. The method according to claim 1, wherein the at least one matched information source is determined using an OPC UA Information model, providing information about entities and data in the OPC UA PubSub automation network.

7. The method according to claim 1, wherein the determining the at least one matched information source comprises using PubSub-specific properties.

8. The method according to claim 7, wherein the PubSub-specific properties comprise publishing intervals and/or information about the at least one publisher describing the information intent.

9. The method according to claim 1, wherein the information intent comprises semantic information.

10. The method according to claim 1, wherein the PubSub meta information comprises frequency of updates, topic names and/or names of FX connections.

11. The method according to claim 1, further comprising obtaining, by the gateway device, security data from the broker, wherein the security data allows the gateway device to retrieve encrypted data of interest.

12. The method according to claim 1, wherein the gateway device comprises an edge device gateway.

13. A system for industrial information identification and retrieval in an OPC UA PubSub automation network, the system comprising:
at least one publisher providing publisher data;
a gateway device that is connectable to the OPC UA PubSub automation network;
wherein the gateway device is configured and operates to:
discover at least one information source in the OPC UA PubSub automation network;
identify and connect to a broker, wherein the broker manages the publisher data provided by the at least one publisher;
determine at least one matched information source from the discovered at least one information source based on information intent of the gateway device and PubSub meta information of the publisher data provided by the broker; and
retrieve the data of interest from the at least one matched information source.

14. A computer-readable storage medium, comprising computer instructions, wherein when the computer instructions are run on a computer, the computer is enabled to perform a method for identification and retrieval of data of interest in an Open Platform Communications Unified Architecture (OPC UA) PubSub automation network, wherein the OPC UA PubSub automation network comprises at least one publisher providing publisher data, the method comprising:
connecting a gateway device to the OPC UA PubSub automation network;
discovering, by the gateway device, at least one information source in the OPC UA PubSub automation network;
identifying and connecting to a broker, by the gateway device, wherein the broker manages the publisher data provided by the at least one publisher;
determining, by the gateway device, at least one matched information source from the discovered at least one information source based on information intent of the gateway device and PubSub meta information of the publisher data provided by the broker;
retrieving, by the gateway device, the data of interest from the at least one matched information source.
